(19) United States
(12) Patent Application Publication
(10) Pub. No.: US 2005/0209867 A1
(43) Pub. Date: Sep. 22, 2005

(54) Automated record searching and output generation related thereto

(75) Inventors: Michael W. Diesch, Battle Creek, MI (US); Bradford L. Hayes, Louisville, CO (US); Robert F. Anastasi, Louisville, CO (US); Tiffany A. Dell, Longmont, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Zenodata Corporation, Louisville, CO (US)

(21) Appl. No.: 10/804,472

(22) Filed: Mar. 18, 2004

(51) Int. Cl. G06F 17/60

(52) U.S. Cl. 705/1

(57) ABSTRACT

A computerized method of searching property records relating to a specific parcel includes receiving property record data for a plurality of parcels into a computer system. The property record data relates to source property record documents. The method also includes storing the property record data in a searchable database and receiving into the computer system an identifier. The method further includes using the identifier to search the database and select from the property record documents a set of relevant documents relating to the parcel. The method also includes using the set of relevant documents to produce a data summary and outputting the data summary from the computer system. The data summary comprises information from which an underwriter can underwrite a title policy, using commonly-accepted title policy underwriting rules, without reference to the source documents, or images thereof, from which the data summary originated.

### CROSS-REFERENCES TO RELATED APPLICATIONS

This application is related to the following co-pending, commonly-assigned and concurrently filed U.S. Patent Applications, the entirety of each of which are herein incorporated by reference for all purposes: Provisional U.S. Patent Application No. ______, entitled “PROPERTY RECORDS DATABASES AND SYSTEMS AND METHODS FOR BUILDING AND MAINTAINING THEM” (Attorney Docket No. 040143-000100); U.S. patent application Ser. No. ______, entitled “DOCUMENT SEARCH METHODS AND SYSTEMS” (Attorney Docket No. 040143-000300); U.S. patent application Ser. No. ______, entitled “DOCUMENT ORGANIZATION AND FORMATTING FOR DISPLAY” (Attorney Docket No. 040143-000400); Provisional U.S. Patent Application No. ______, entitled “CONFIDENCE-BASED NATURAL LANGUAGE PARSING” (Attorney Docket No. 040143-000500); and Provisional U.S. Patent Application No. ______, entitled “CONTEXTUAL CONVERSION OF LANGUAGE TO DATA” (Attorney Docket No. 040143-000600).

### BACKGROUND OF THE INVENTION

The present invention relates generally to search systems. More specifically, the present invention relates to systems and methods for performing property records searches.

The practice of recording real property transfers is well known. Local governments (e.g., counties) typically administer the recording system. Most any time a property owner transfers an interest in his property, a document evidencing the transfer is recorded in the county where the property is located, thus providing notice to others of who owns what interest in the property. The property owner may transfer all his right, for example, when an individual sells his primary residence, in which case a deed usually is recorded. In another example, a property owner may transfer only a right to foreclose on a mortgage if he does not make required payments, in which case a mortgage may be recorded. Those skilled in the art will appreciate other examples.

Before an entity (grantee) gives value in return for an interest in property, that entity typically desires to confirm that the property owner (grantor) has the right to transfer the interest. It is common practice for title companies to provide this confirmation in the form of “title policies.” Essentially an owner's title policy is an insurance policy that insures the grantee against the risk of receiving a defective interest in property. Before issuing a title policy, a title company physically searches recorded property records to create a chain of title and identify potential encumbrances to effective transfer of any of the bundle of rights associated with the subject property. Likewise, before a lender lends money secured by property, the lender typically searches the property records to assess the quality of the collateral. Such lenders purchase a loan policy to insure the lender against the risks of making a loan on a property with potential title problems. These are, of course, but two examples of instances in which searching property records is desirable, albeit probably the most common examples.

For a number of reasons, the process of searching property records is labor intensive. Property records typically are recorded in chronological order, not according to location, thus complicating the task of identifying recorded documents relating to a specific parcel from among the thousands of recorded documents. Further, any given parcel is a subdivided portion of a larger parcel and the property description is not consistent. Further still, a variety of documents are used to record transfers of property interests, and a standard format does not exist. Errors in recorded documents or in the indexing system used to locate the records further compound the problem. Probably most importantly, however, is the lack of an electronic searching system that includes all the information an underwriter may need to know about a parcel before issuing a policy or approving a loan relating to the property.

Thus, embodiments of the present invention relate to systems and methods for improving the efficiency of property record searches, as well as analyzing and summarizing the results thereof.

### BRIEF SUMMARY OF THE INVENTION

Embodiments of the invention thus provide a computerized method of searching property records relating to a specific parcel. The method includes receiving property record data for a plurality of parcels into a computer system. The property record data relates to source property record documents. The method also includes storing the property record data in a searchable database and receiving into the computer system an identifier. The method further includes using the identifier to search the database and select from the property record documents a set of relevant documents relating to the parcel. The method also includes using the set of relevant documents to produce a data summary and outputting the data summary from the computer system. The data summary comprises information from which an underwriter can underwrite a title policy, using commonly-accepted title policy underwriting rules, without reference to the source documents, or images thereof, from which the data summary originated.

In some embodiments the title policy is an American Land Title Association (ALTA) Loan Policy, an ALTA Owner's Policy, an ALTA Short Form Residential Loan Policy, a Homeowner's Policy of Title Insurance for a One-to-Four Family Residence, Standard Exceptions to the ALTA Loan Policy, or endorsements to an ALTA policy. The data summary may be a display screen on a computer monitor and/or a printed document. The printed document may be a title abstract, which, in some embodiments is generated exclusively from the property record data. The printed document may be a policy. The data summary may be a stream of data directed to a second computer system that is different from the first computer system. In some embodiments, the method includes thereafter using the stream of data to populate a document, which may be a policy, deed, mortgage, commitment, closing-related document, template, or form.

In some embodiments, the method includes creating at least one index relating to the property record data and using the at least one index together with the identifier to select relevant documents. Using the identifier to search the database and select from the property record documents a set of relevant documents relating to the parcel may include using the identifier to search the database and select from the property record documents a set of potentially relevant documents relating to the parcel and applying logic to organize the documents. Applying logic to organize the documents may include relating one or more documents to one or more other documents to identify any unreleased mortgages. Applying logic to organize the documents may include relating one or more documents to one or more other documents to identify any defective transfers. Applying logic to organize the documents may include relating one or more documents to one or more other documents to identify any unreleased liens. Applying logic to organize the documents may include relating one or more documents to one or more other documents to identify a good stop in a chain of title. Relevant documents may include deeds, mortgages, assignments, liens, mortgage releases, lien releases, and tax assessor's reports. The property record data may be received into the computer system before the relevant document set is selected. The identifier may be grantor name, legal description of the parcel, physical address of the parcel, or a specific recorded document.

In some embodiments receiving property record data for a plurality of parcels into a computer system includes receiving a plurality of images representing property records, converting the images to electronic image data, paginating the electronic image data into related groups representing individual documents, identifying the document type, identifying data fields on each document, using a combination of computer-implemented processes and manual processes to convert information in the data fields into electronic information, and organizing the electronic information into data records.

In some embodiments, the data summary may include a listing of the relevant documents. The listing of the relevant documents may include a score for at least one of the documents that indicates the degree of relevance of the document. The listing of the relevant documents may include a hyperlink for at least one of the documents that returns an image of the document. The data summary may include a score that provides an indication of the marketability of the parcel. The score may be a grade.

Other embodiments include a system for generating a data summary relating to a specific parcel. The data summary includes data from which an underwriter can issue a commitment or approve a loan, using commonly-accepted underwriting rules, without reference to source documents from which the data for the data summary originated. The system includes a host computer system having a processor and a storage arrangement in communication with the processor. The system also includes software that programs the processor to receive property record data for a plurality of parcels. The property record data relates to source property record documents. The software also programs the processor to store the property record data in a searchable database in the storage arrangement and receive an identifier. The software also programs the processor to use the identifier to search the database and select from the property record documents a set of relevant documents relating to the parcel and use the set of relevant documents to produce the data summary. The software also programs the processor to output the data summary.

In some embodiments, the system includes a computer monitor for displaying the data summary. The system may include means for producing a printed document from the data summary. The system may include a communications arrangement for directing the data summary to a second computer system that is different from the first computer system.

In some embodiments, the system includes an input system that includes means for receiving a plurality of images representing property records and means for converting the images to electronic image data. The system also includes means for paginating the electronic image data into related groups representing individual documents and means for identifying the document type. The system also includes means for identifying data fields on each document and means for using a combination of computer-implemented processes and manual processes to convert information in the data fields into electronic information. The system also includes means for organizing the electronic information into data records.

In still other embodiments, the invention provides a computer-readable medium having stored thereon computer executable instruction for implementing a computerized method of searching property records relating to a specific parcel. The method includes receiving property record data for a plurality of parcels into a computer system. The property record data relates to source property record documents. The method also includes storing the property record data in a searchable database, receiving into the computer system an identifier, using the identifier to search the database and select from the property record documents a set of relevant documents relating to the parcel, using the set of relevant documents to produce a data summary, and outputting the data summary from the computer system. The data summary includes information from which an underwriter can underwrite a title policy, using commonly-accepted title policy underwriting rules, without reference to the source documents, or images thereof, from which the data summary originated.

In some embodiments, the method further includes creating at least one index relating to the property record data and using the at least one index together with the identifier to select relevant documents. The data summary may include a score that provides an indication of the marketability of the parcel. The score may be a grade.

In other embodiments, the invention provides a method of searching property records. The method includes receiving property record data relating to a plurality of parcels into a computer system. The data relates to source documents. The method also includes storing the data in a searchable database and receiving into the computer system a request for data summary relating to the specific parcel. The method further includes using the data to generate the data summary, outputting the data summary, and using the data summary to underwrite a title policy without reference to the source documents. The property record data may be received before the data summary is requested. The data summary may be a stream of data directed to a second computer system that is different from the first computer system. The method may include thereafter using the stream of data to populate a document. The document may be a policy, deed, mortgage, or commitment. The data summary may be a listing of the relevant documents. The listing of the relevant documents may include a score for at least one of the documents that indicates the degree of relevance of the document. The listing of the relevant documents may include a hyperlink for at least one of the documents that returns an image of the document. The data summary may include a score that provides an indication of the marketability of the parcel. The score may be a grade.

In still other embodiments, the invention provides a method of searching property records. The method includes receiving property record data relating to a plurality of parcels into a computer system. The data relates to source documents. The method also includes storing the data in a searchable database and receiving into the computer system a request for data summary relating to the specific parcel. The method also includes using the data to generate the data summary and displaying the data summary. The method further includes using the data summary to issue a commitment for a title policy without reference to the source documents. The property record data may be received before the data summary is requested.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a title searching system according to embodiments of the system.

FIG. 2 illustrates a title searching method according to embodiments of the invention.

FIGS. 3A and 3B illustrate exemplary source property record documents.

FIG. 4 illustrates a method of converting property records to data according to embodiments of the invention.

FIGS. 5A-5F illustrate exemplary output documents according to embodiments of the invention.

FIGS. 6A-6F illustrate exemplary display screens for interacting with the system according to embodiments of the invention.

### DETAILED DESCRIPTION OF THE INVENTION

Embodiments of the present invention provide systems and methods for automating the process of property records searching. In some embodiments, the present invention produces a data summary in response to a query that identifies a parcel, a grantor, and/or a specific document associated with the parcel. In some embodiments, the data summary is a title abstract. A title abstract according to some embodiments has sufficient information to allow a title policy underwriter (title examiner, examiner, underwriter, or abstracter) to provide a title commitment using commonly-accepted title policy underwriting rules. Thus, the systems and methods disclosed herein can produce or be used to produce a title commitment and/or title policy without reference to the source property record documents. In some embodiments, the data summary has sufficient information to assess the quality of the title of a parcel that is being used to secure a loan, using commonly-accepted loan underwriting rules, without reference to the source property record documents.

While embodiments of the invention disclosed herein are described in relation to searching property records associated with real property, this is not a requirement. The systems and methods described herein may be applied to records searches relating to personal property, professional licenses, corporate filings, and the like. Those skilled in the art will recognize many other examples in light of the disclosure herein. Further, while the specific examples used herein refer to title policies, title abstracts, title commitments, and other title and real estate industry-related product outputs, these examples are not intended to limit the scope of the invention. As previously mentioned, embodiments of the invention may be used by loan underwriters to assess the quality of the collateral (i.e., title for the parcel) and approve a loan, using commonly-accepted loan underwriting rules, without reference to the source property record documents. Embodiments of the invention may produce or be used to produce other types of output, including standard templates or forms and derivates of these templates or forms: American Land Title Association (ALTA) Loan Policy; ALTA Owner's Policy; ALTA Short Form Residential Loan Policy; Homeowner's Policy of Title Insurance for a One-to-Four Family Residence; Standard Exceptions to the ALTA Loan Policy; endorsements to ALTA policies; a Title Information Report (TIR) or “Prelim”; a title commitment for policies such as the foregoing; a Full Abstract—Refinance; a Full Abstract—Purchase; an “O&E”; and the like.

In some embodiments, the searching process is enabled by the collection of a comprehensive set of property record data covering a specified period of time for a given geographic area. The data set is then stored in a searchable database. For example, in a specific embodiment, data from all property records in a particular county for the past ten years is reduced to electronic form. In another embodiment, the period includes all records going back to the time of the original land grant. In other embodiments, the time period may be longer or shorter than these examples and may be determined based on local practice, underwriting requirements, the statute of limitations relating to correcting defective property transfers in the subject region, or the like. Other examples exist.

While the geographic region typically is a county, other larger or smaller regions may be used. For example, some embodiments may operate only on a subdivision or planned urban development (PUD), while others operate on an entire state or region of the country. The region typically is determined to be the region covered by the recording entity.

The records may come from a county courthouse, state courthouse, federal court records, bankruptcy records, tax and assessor records, Geographic Information System (GIS) records, and the like. The records from which the data set is collected may include deeds, mortgages, UCC filings, liens, releases of liens, releases of mortgages, judgments, lis pendens, federal tax liens, state tax liens, maps, plats, and the like. The items of data collected include: property address, legal description, grantor name, grantee name, document date, recordation data, reception number, document type, other items to be identified hereinafter, and the like.

Embodiments of the present invention do not merely collect electronic images of recorded documents. Further, embodiments of the invention do not merely digitize data (e.g., grantor, property address, legal description, and the like) to create electronic indexes used to locate source documents. Embodiments of this invention reduce a comprehensive set of property records to a form that may be entered into a searchable database and used to complete the searching process, not merely locate source documents that then must be examined. The systems and methods described herein produce output (e.g., a paper document, an image on a computer screen, an electronic data file) that contains sufficient information to underwrite any of many different types of title commitments or title policies, as referenced earlier herein, or the like, without reference to the source documents. Of course, the systems and methods described herein may be used for other purposes, such as, for example, legal disputes, real estate research and due diligence, constructing an offer to buy, fraud detection, loan portfolio risk management, easement identification, data mining, marketing, or merely to satisfy some curiosity relating to the ownership history of a parcel. Many other examples are possible.

The data to be included in the set may be determined by commonly-accepted rules for the particular task. These may include: local title policy underwriting rules, federal loan underwriting rules, state insurance rules, local loan underwriting rules, customer-specific rules, and the like. As an example, if commonly-accepted title policy underwriting rules base an underwriting decision on whether a particular parcel abuts a body of water, then the data set will include a field for waterfront property information. In some examples, this may be merely a binary field having one value for waterfront property and another for non-waterfront property. In other examples, however, additional fields may be included that indicate the type of body of water, the portion of a parcel that abuts the water, and the like. Many other such examples are possible.

In some embodiments, the data is document-centric, although other examples are possible (e.g., person-centric; parcel-centric). In document-centric embodiments, even though the information is stored in searchable form, for example in a relational database, the data is organized, at least initially, according to documents. The documents correspond to specific recorded property records having potentially-relevant property data. Thus, in these embodiments, the automated searching process resembles the process a searcher might perform manually: the process identifies documents having data related to a property and evaluates the data to determine if the document is relevant to issuing a policy on the property. Irrelevant documents are ignored, and the data on relevant documents are summarized in an abstract from which an underwriter may generate a commitment.

In some embodiments, the abstract (or other output) may include a list of documents and a relevance score for each document. The score may be generated using any of a number of scoring algorithms. For example, the score may be based on a number of comparisons between the document being scored and a source document or group of documents. The more closely the data on the document match that on other documents or the data used to initiate the search, the higher the score and vice versa. The score may be based, at least in part, on the number of ways a document is located (e.g., name search, grantor search, address search, legal description search, and the like). The more searches that return a document, the more likely the document is to be relevant and the higher the score. The score may be weighted to favor data elements of greater significance. Many such examples are possible.

In some embodiments, the output may include a score, a grade, or a list of exceptions that summarizes the data gathering process in a meaningful way in a manner similar to the way credit reporting agencies score credit reports. The score could be based on specific customer requirements or could be industry standard scores.

As mentioned previously, the output may assume any of a number of forms. The output may be electronic or paper, for example. Paper output may be an abstract, portions of an abstract, a policy, a chain of title, a commitment, a document list, and the like. In addition to these, electronic output may include hyperlinks that allow a user to obtain more detailed information about an item or navigate among different portions of the output. For example, although not needed to underwrite a policy, an underwriter may desire to view an image of a relevant document. A hyperlink in a listing of documents may be used to return the image. Many other examples are possible.

In some embodiments, the output includes an electronic file having data that may be used for any of a number of purposes. The file, which may be transmitted as a data stream over a network between computing devices, may be an ASCII text file, a comma-delimited file, or the like. The file may be in EDI, EDIFACT, ANSI X12, or other suitable format. The file may include XML elements or tags, XML attributes, DTDs, LDDs XML schemas, and the like. Many other examples are possible and apparent to those skilled in the art in light of this disclosure. The information transmitted in the electronic file may be used, for example, to populate fields in documents such as policies, mortgages, deeds, and the like.

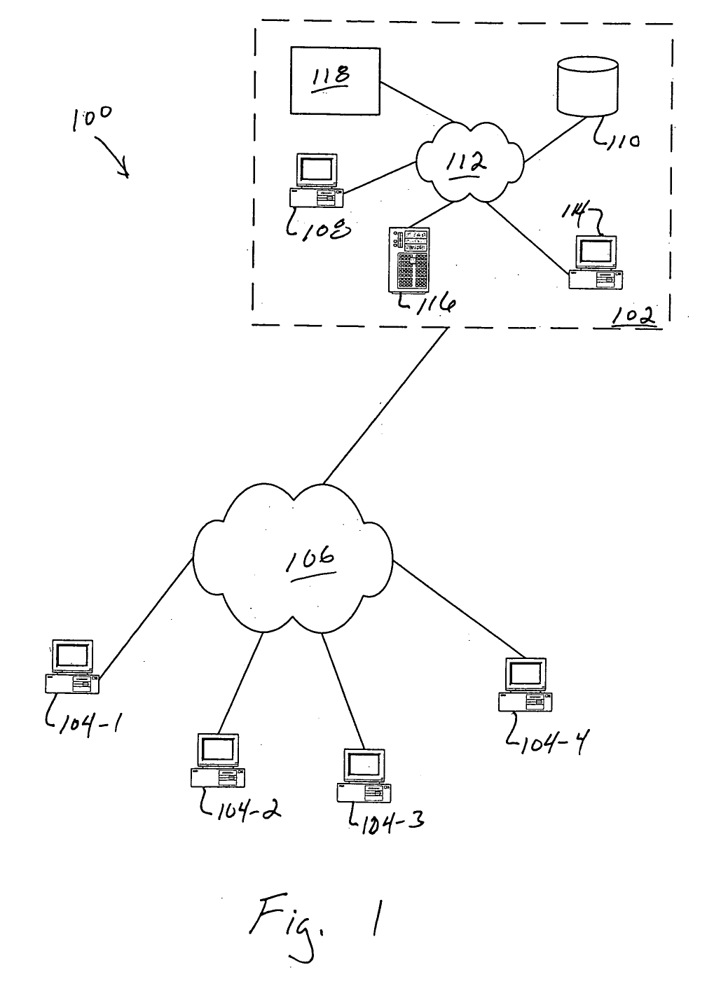

Having described embodiments of the invention generally, attention is directed to FIG. 1, which illustrates an example of a property records searching system 100 according to more specific embodiments of the invention. The system 100 includes a host computer system 102. The host computer system 102 may include any of a number of computing devices, peripheral devices, network devices, input devices, output devices, and the like. All the devices that comprise the host computer system 102 may be co-located at a single facility or distributed geographically. In a specific embodiment, the host computer system 102 is a single computing device that users 104 may access via a network 106. Many other examples are possible.

In a specific embodiment, the host computer system 102 includes a workstation 108, a data storage arrangement 110, and an internal network 112 that allow the two to communicate. The workstation 108 may be any computing device or combination of computing devices capable of performing the processes described herein. The workstation 108 includes a processor and software that programs the processor to operate according to the teachings herein. The storage arrangement 110 may be, for example, any magnetic, electronic, or optical storage system, or any combination of these. The storage arrangement may be a server, or combination of servers having RAM, ROM, hard disk drives, optical drives, magnetic tape systems, and the like or any combination. In some embodiments, each geographic region is represented by a server or group of servers. Many other examples are possible. The internal network 112 may be any of a number of well known wired or wireless networks or combinations thereof. For example, the internal network may be a LAN, WAN, intranet, the Internet, or the like. Many other examples are possible. The host computer system also may include administrative computers 114 (e.g., personal computers, laptop computers, and the like) that may be used to assist in the operation of the system. The host computer system 102 also may include network interfaces 116 (e.g., web server) that enable communication between the host computer system 102 and users 104.

The host computer system 102 also may include an input system 118. In its most basic form, the input system 118 receives source property records, converts the property records to searchable data, and delivers the data to the storage arrangement. This process will be described in greater detail hereinafter. The input system 118 need not be a single device, nor located at a single location.

The network 106 may be any wired or wireless network, or any combination thereof. In a specific embodiment, the network 106 is the Internet. The users 104 may be any computing device capable of providing a user access to the host computer system 102. In a specific embodiment, the user 104-1 is an underwriter's or abstracter's desktop computer through which he accesses the host computer system, via the Internet, for purposes of performing a search and underwriting a policy or loan for a customer.

Those skilled in the art will appreciate that the foregoing is but one example of a system according to embodiments of the invention. Many other examples are possible.

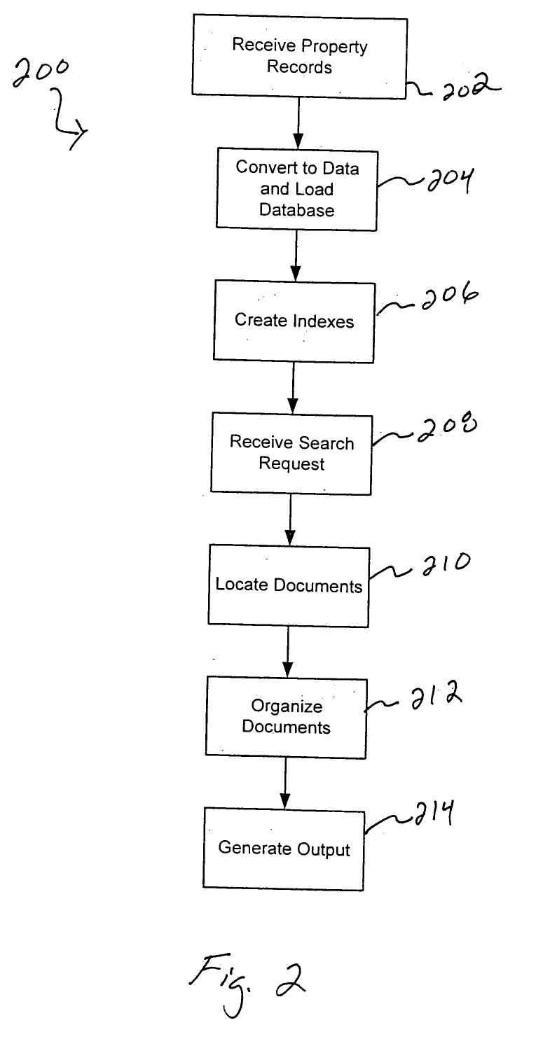

Having described an exemplary system according to embodiments of the invention, attention is directed to FIG. 2, which illustrates an exemplary method 200 according to embodiments of the invention. The method may be implemented in the system 100 described above or in another suitable system. Those skilled in the art will appreciate that alternative methods according to embodiments of the invention may include more or fewer steps and that the steps described herein may be performed in different orders than that described with respect to this exemplary embodiment.

The method 200 begins with the receipt of property records at block 202. The records may be received in any of a number of forms. For example, in some embodiments, the property records are received as paper copies of all documents recorded in a given jurisdiction. In other embodiments, the property records are received as a collection of image files. The image files may be stored in magnetic (e.g., on one or more computer disks) or optical (e.g., on one or more CDs) form, or the like, or a combination of such. The image files may include microfilm or microfiche images. Many other examples are possible.

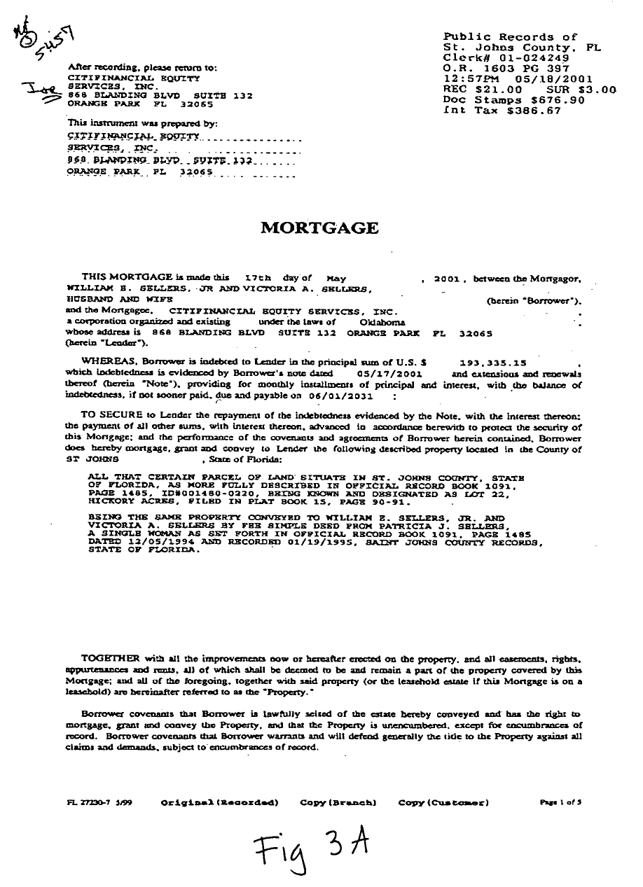

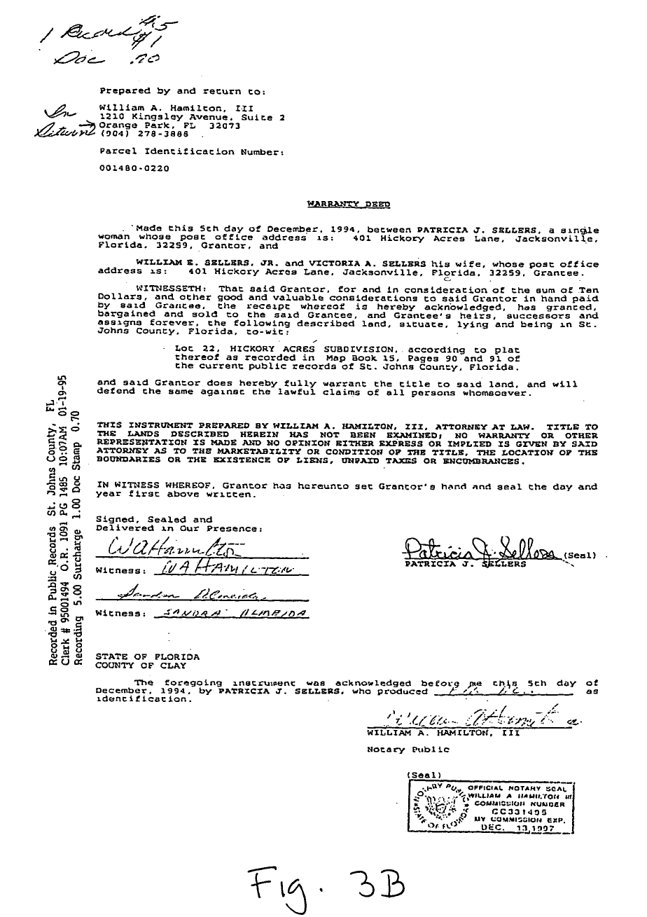

As mentioned previously, the property records may include deeds, mortgages, liens, releases, and the like. FIGS. 3A and 3B illustrate examples of the types of property records that serve as source documents according to embodiments of the invention and the data that are gathered there from. For example, FIG. 3A illustrates a mortgage. The mortgage includes a mortgagor name, a mortgagee name, a transaction date, a legal description, a recordation date, and the like. FIG. 3B illustrates a warranty deed. The deed includes grantor, grantee, legal description, and the like. Those skilled in the art will appreciate many other examples of recorded documents and the data contained thereon.

At block 204, the property records are converted to data and loaded into a database such as the storage arrangement 110 of FIG. 1. This may involve use of the input system 118 of FIG. 1. This process is described in greater detail hereinafter and in previously incorporated provisional U.S. Patent Application No. ______, (Attorney Docket No. 040143-000100). Briefly, however, this comprises extracting from the property records all data needed to underwrite a policy, loan or the like according to commonly-accepted underwriting rules. A specific embodiment includes extracting the following field codes, some of which are followed by comments: RECEPTION_NUM=0; BOOK=1; PAGE=2; RECORD_DATE=3; DOCUMENT_DATE=4; DOLLAR_AMOUNT=5; INT_RATE=6; PREVIOUS_DOCUMENT_DATE=7; SOCIAL_SECURITY=8; // new, for liens MATURITY_DATE=9; // new, for liens CASE=10; JURISDICTION=11; PREVIOUS RECEPTION_NUM=12; PREVIOUS_BOOK=13; PREVIOUS_PAGE=14; DOC_FEE 15; LEGAL_DESCRIPTION=16; DOC_TITLE=17; GRANTEE=18; GRANTOR=19; THIRDPARTY=20; MISC_INDEX_DATA=21; FOURTHPARTY=22; CREDITLIMIT=23; // credit limit text STREETADDRESS=24; // amount, if found and CREDITLIMIT=yes SIGNATURE=25; // signature found on doc RERECORDED=26; // rerecording information found on doc PREVIOUSDOCKETNUMBER=27; DECLARATIONSRECORDINGDATE=28; // with label COLLATERALLISTED=29; CONDOYESNO=30; RERECORDEDRECORDINGDATE=31; RERECORDEDRECORDINGREASON=32; POAREASON=33; TERMINATIONDATE=34; // with label SALEDATE=35; VOLUME=36; TYPEOFPROPERTY=37; APPURTENANCES=38; STARTDATE=39; // with label PERCENTOWNERSHIP=40; LARGEVSSMALLPUDFLAG=41; DOCKETNUMBER=42; REDEMPTIONMADEBY=43; SALEIDNUMBER=44; CAPTUREDTAXIDNUMBER=45; PUDYESNO=46; HELDASLEASEHOLDYESNO=47; HELDASFEESIMPLEYESNO=48; DEFENDANTDEBTOROBLIGEESSN=49; DEFENDANTDEBTOROBLIGEEFEIN=50; PLAINTIFFCREDITORCLAIMANTSSN=51; PLAINTIFFCREDITORCLAIMANTFEIN=52; CORRECTEDAMENDEDREASON 53; UCCRECNUMBER=54; PARCELIDNUMBER=55; CONCLUSIONS=56; PURPOSEOFEASEMENT=57; AFFECTEDPROPERTY=58; PREVDOTAMOUNT=59; NEWDOTAMOUNT=60; TENANCY=61; CORRECTEDAMENDEDBOOLEAN=62; CORRECTEDAMENDEDRECORDINGDATE=63; CORRECTEDAMENDEDPREVIOUSRECEPTIONNUMBER=64; MERSNUMBER=65; CERTIFIED=66; // Is the court decree certified. Typically is yes/no boolean. SURCHARGEFEE=67; // Surcharge noted on document. INTANGIBLETAX=68; NOTARY=69; TORRENSTITLENUMBER=70; WITNESSES=71; HOMESTEAD=72; PREV_BOOK_PAGE=73; // may replace the two separate PREV_BOOK & PREV_PAGE fields. Those skilled in the art will recognize many other examples in light of the disclosure herein.

Once extracted, the data are loaded into a database, for example a searchable relational database, and stored for future use. The data may be stored such that all data from a specific record, parcel, person, or the like, is logically grouped together. This preserves the data as a document, yet allows the data to be searched in many different ways.

At block 206, indexes are created that enhance the efficiency of future searches. Creating indexes may include creating a unique pointer for individual parcels and using the pointers to identify any document (i.e., data group) relating to the parcel. Other indexes may be created for grantors, grantees, and the like. Those skilled in the art will recognize other possibilities for creating indexes in light of this disclosure.

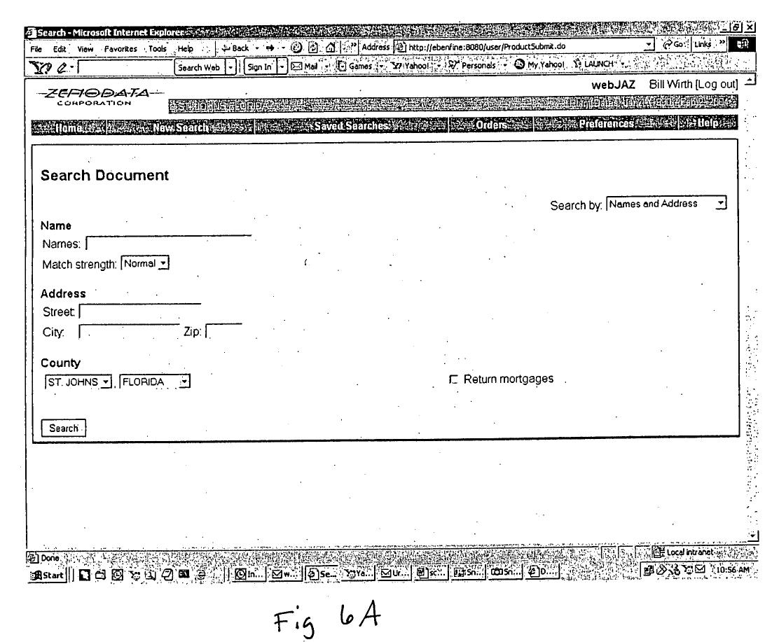

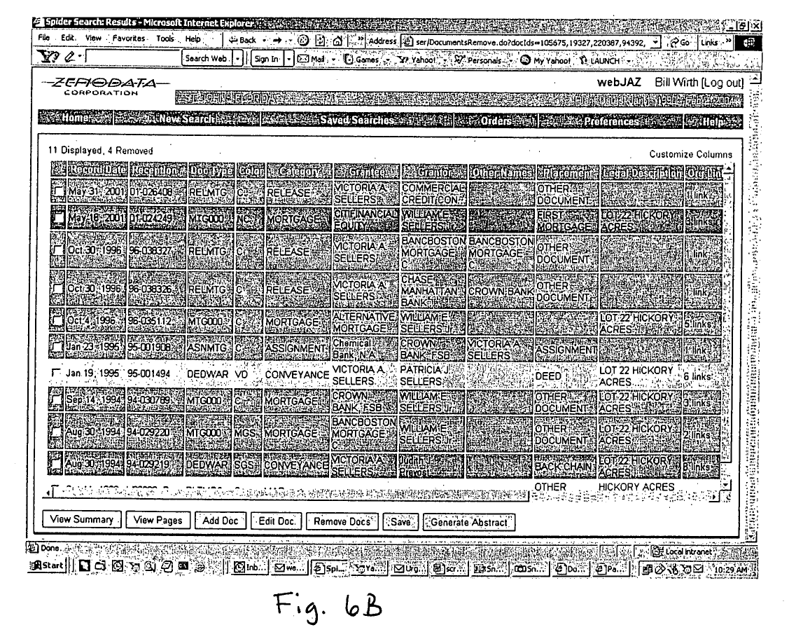

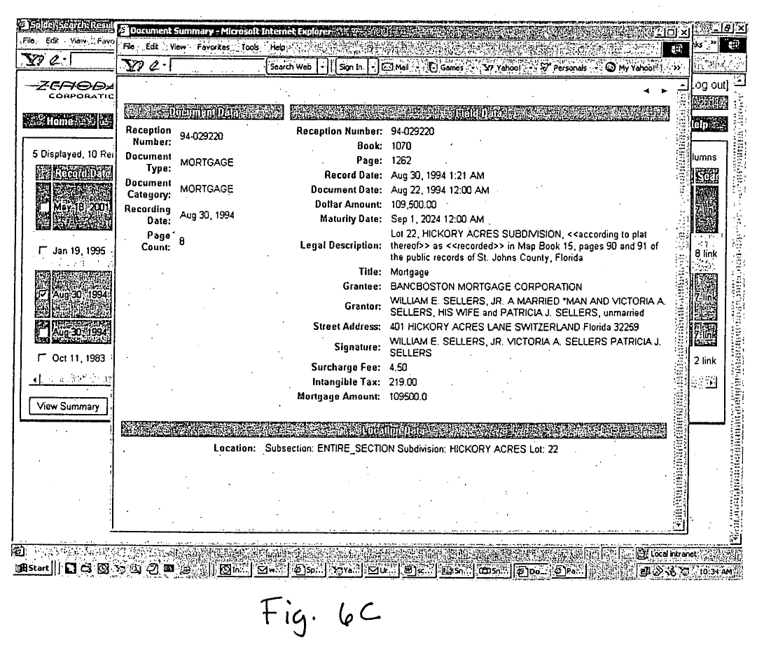

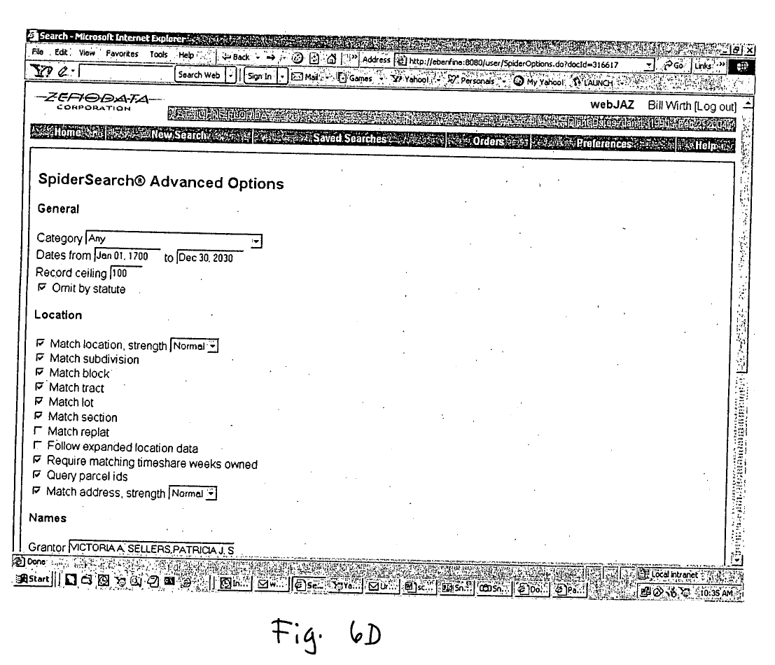

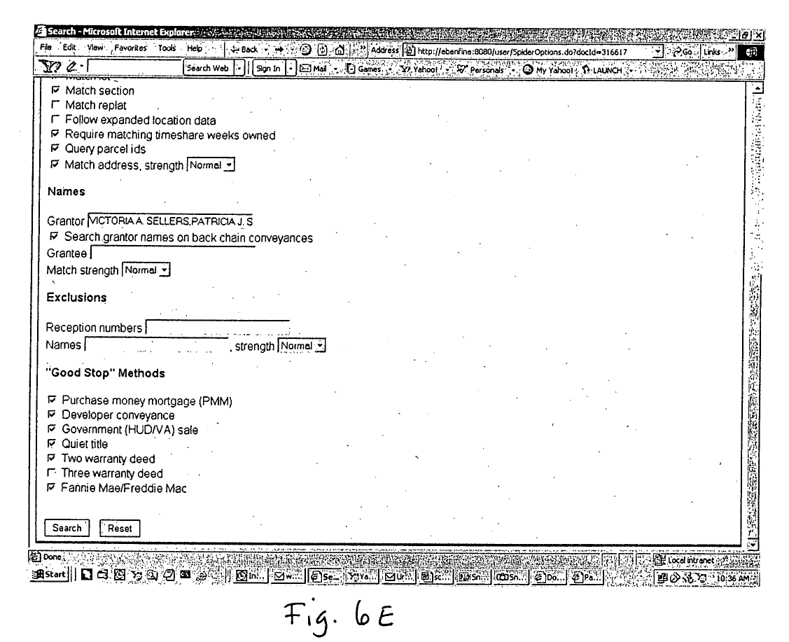

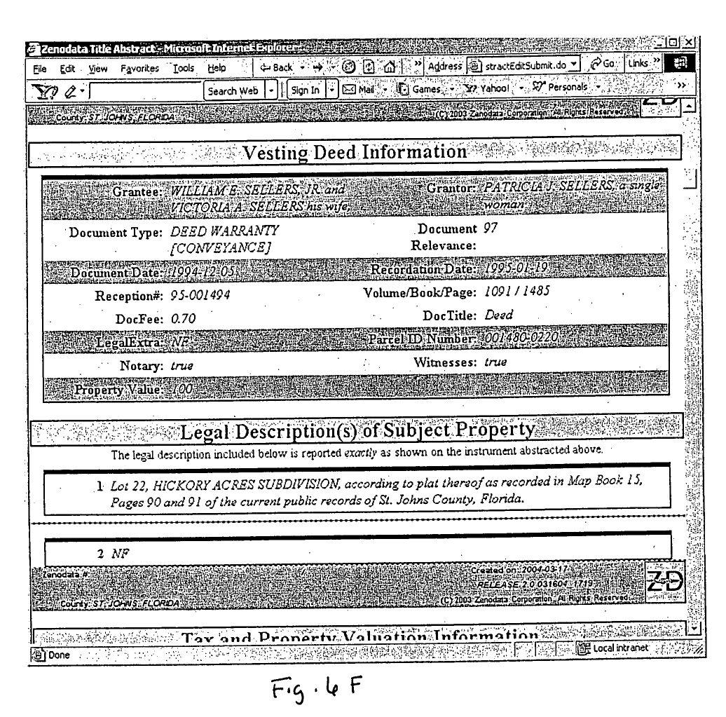

At block 208, a search request is received. In a specific embodiment, this comprises receiving a request via a network (e.g., the Internet, or other network represented by the network 106 of FIG. 1) from a user, such as one of the users 104 of FIG. 1. The request may comprise one or more data elements on which the user would like to base the search. Exemplary data elements include the property address, a legal description of the property, the grantor in a property transaction, and the like. In some embodiments, the user may supply a specific document (e.g., by providing the reception number of the recorded document) on which the user desires the search to be performed. The user may use display screens such as those described hereinafter with respect to FIGS. 6A-6F. The request also may include a request for specific output. For example, the user may want a document list, an abstract, a policy, a title marketability score or grade, and/or the like.

At block 210, potentially relevant documents are located. This process is described more fully in previously-incorporated U.S. patent application Ser. No. ______, entitled “DOCUMENT SEARCH METHODS AND SYSTEMS” (Attorney Docket No. 040143-000300). Briefly, however, this comprises using the stored data to identify documents potentially related to the data elements in the user's request. Whether a document is relevant may be based on the type of search the user requested. The search may use one or more indexes created at block 206 to improve the efficiency of the search. With respect to some embodiments, searches may locate potentially relevant documents in multiple ways, for example, using the grantor, the legal description, the address, and/or the like. As documents are located, additional searches may be performed using data from these documents. Thus, a document may be identified as potentially relevant based on more than one data element. This helps to lessen the possibility that a relevant document will not be located due to typographical errors or other mistakes present on the recorded document.

Once located, potentially-relevant documents are organized at block 212. Organizing documents is more fully described in previously-incorporated U.S. patent application Ser. No. ______, entitled “DOCUMENT ORGANIZATION AND FORMATTING FOR DISPLAY” (Attorney Docket No. 040143-000400). Briefly, however, this involves any of a number of processes that correlate documents in a manner previously accomplished manually. For example, this may involve matching mortgages with mortgage releases, matching liens with lien releases, constructing a chain of title, locating a good stop for a chain of title, matching multiple grantees in a transfer to grantors in a subsequent transfer, and the like.

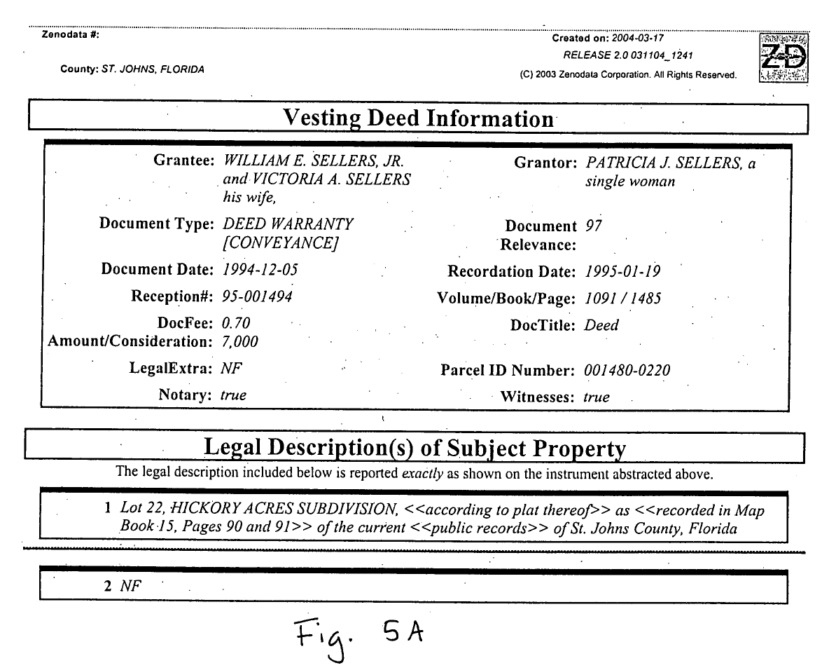

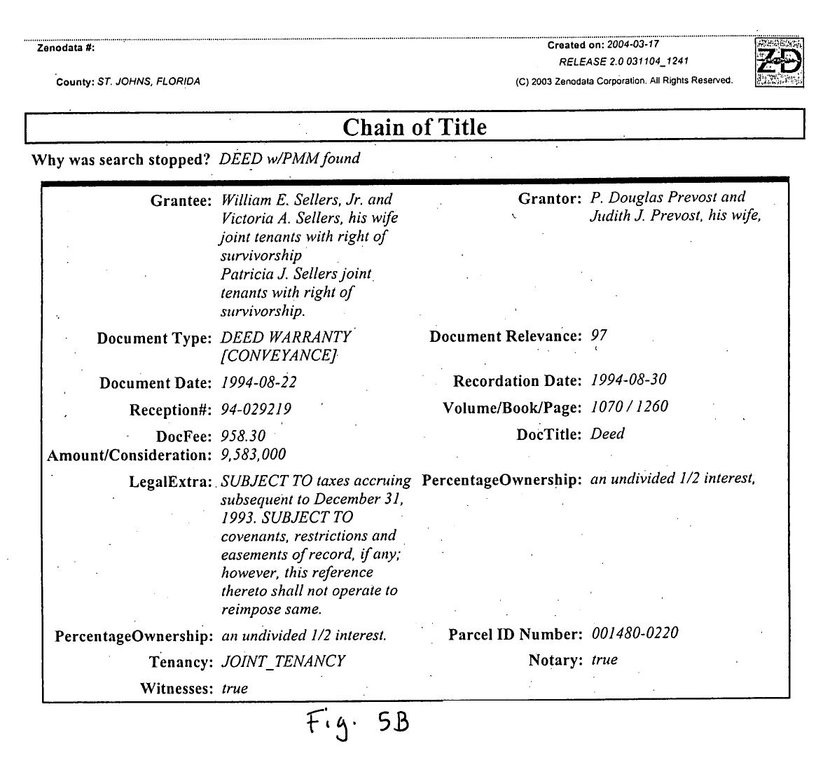

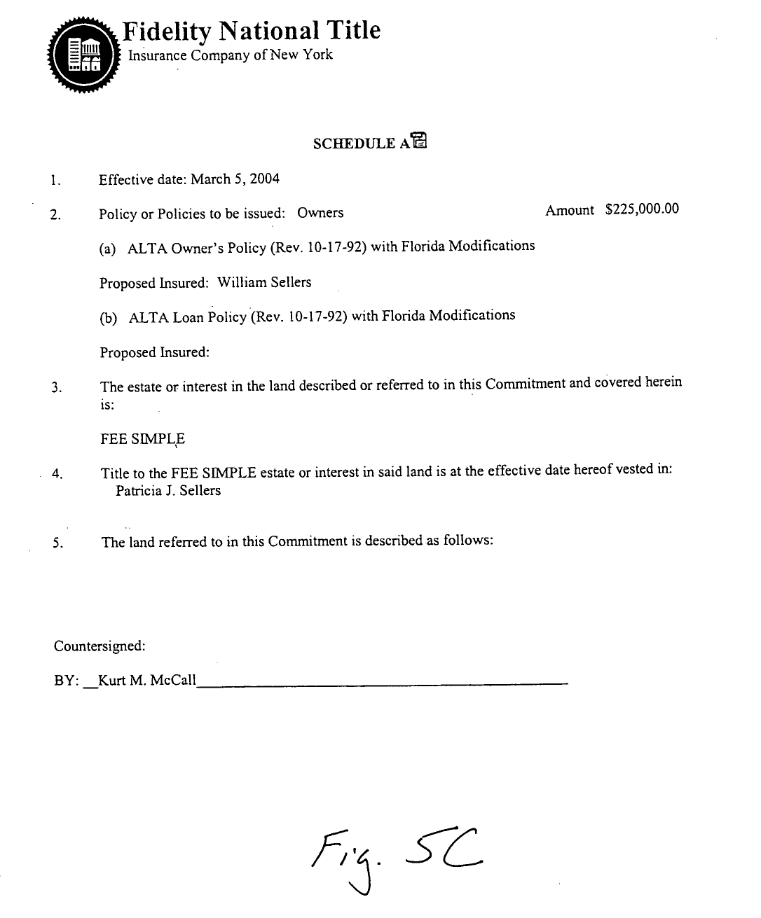

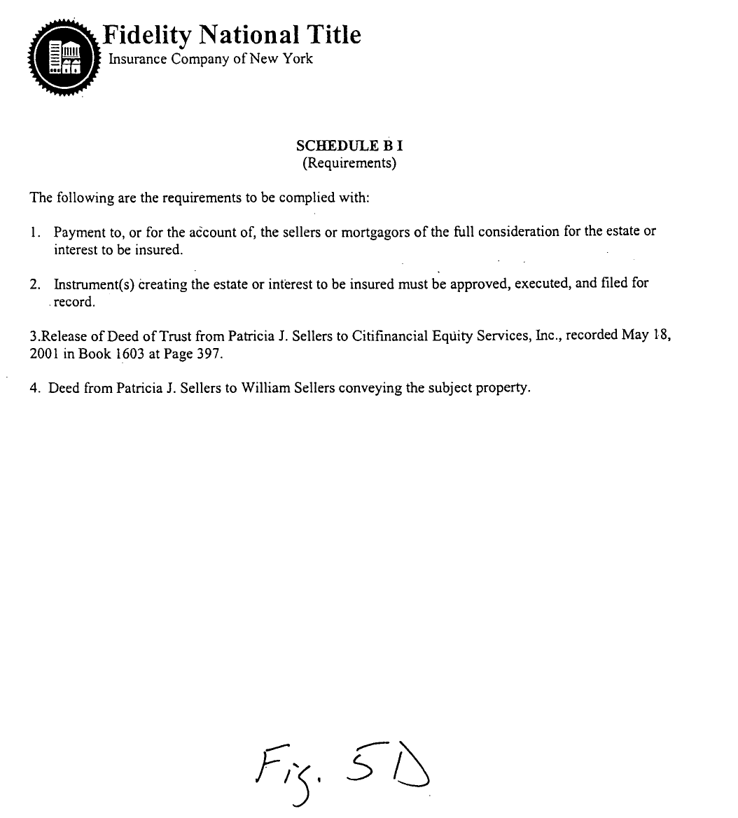

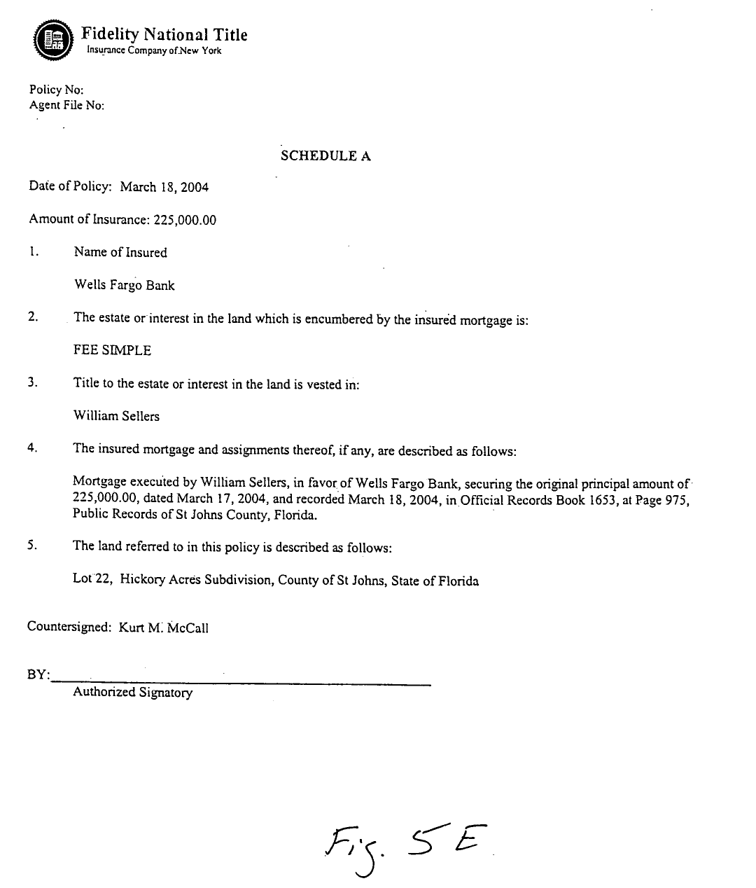

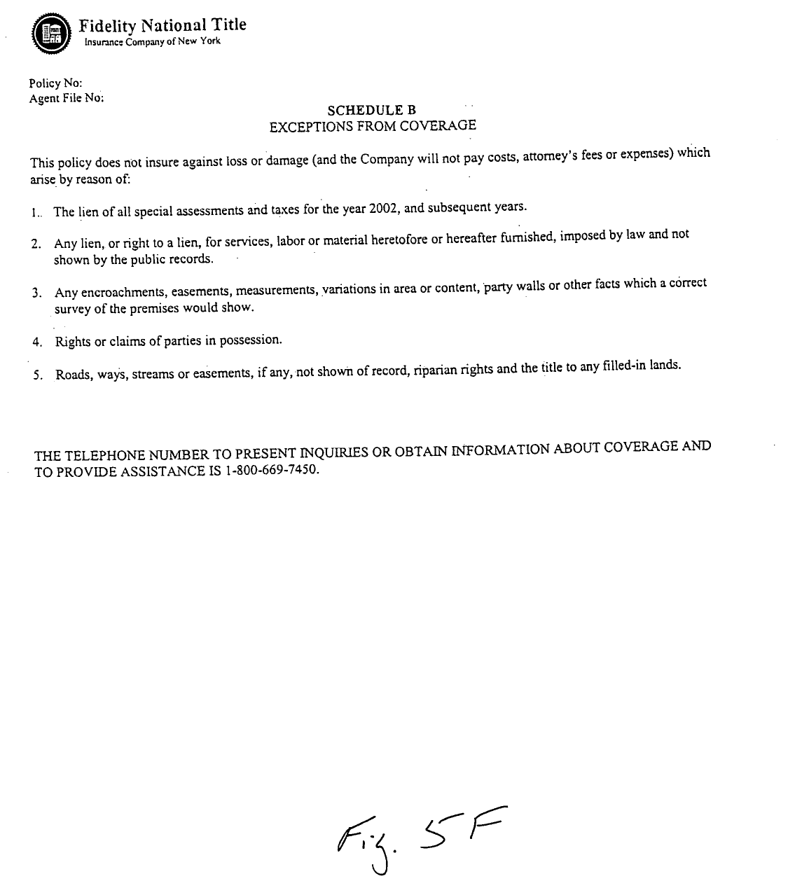

At block 214, output is produced. The output may comprise any or all of the items identified in the user's request. The output may be an electronic file sent to the user, a display screen on the user's computer, a fax to the user, a printout mailed to the user, and the like. If the output is electronic, it may include hyperlinks to more detailed information, to document images, and the like. Exemplary output documents are described hereinafter with respect to FIGS. 5A-5F.

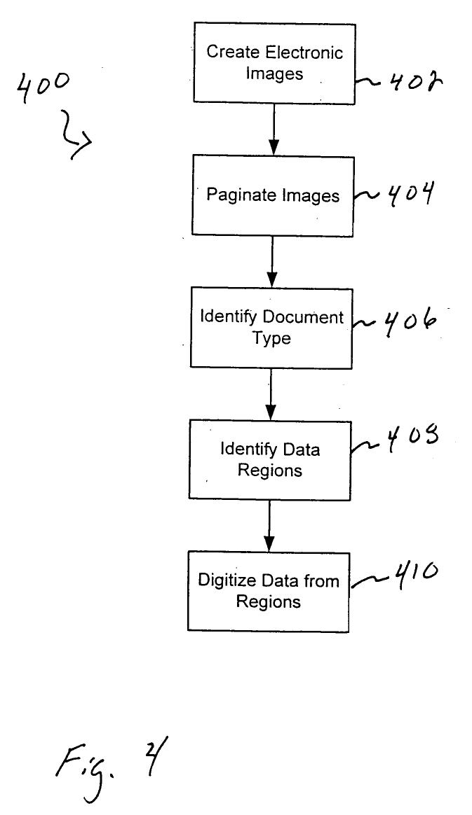

Attention is directed to FIG. 4, which illustrates an exemplary data input method 400 according to embodiments of the invention. The method 400 may be implemented in the data input system 118 of FIG. 1. This process is described in greater detail in previously incorporated Provisional U.S. Patent Application No. ______, (Attorney Docket No. 040143-000100). At block 402 electronic images are created of recorded property records. In some embodiments, this is done by the recording entity; in others, this is done by other entities. The process may involve scanning from paper, microfilm, microfiche, and the like.

The process continues at block 404 wherein the electronic images are logically paginated and grouped. Many recorded documents extend over several pages and identifying breaks between documents may be necessary. This process may be accomplished manually or electronically. If accomplished electronically, the input system 118 may be programmed to recognize various indications of a document break. When such a break is encountered, the system inserts an indicator that signals the break for future operations.

At block 406, each group of pages representing a common document is evaluated to identify the document's type. This also may be done electronically or manually. If done electronically, the input system 118 may be programmed to identify document titles or other indicators of a document's type. The input system 118 also may programmed to evaluate the content of a document, using, for example, optical character recognition (OCR), to determine the document type based on the content. Other examples are possible.

At block 408, data regions are identified on the document. This process may be assisted by having previously identified the document type. Certain types of documents have consistent data regions. Often the regions are located at a consistent location on the document. Thus, in some embodiments the process may be automated and may use OCR to evaluate the content of the region to confirm proper identification. Although OCR may be used, it is not necessary at this stage to parse the content. It is sufficient to merely confirm that the content “looks like a legal description,” for example.

Once the data regions are identified, the content of the regions is digitized at block 410. Digitizing the content involves converting the image information to searchable data that may be loaded into a database. In some embodiments, this involves using OCR and translation algorithms to parse the information, evaluate its content, segment it into appropriate data elements, or post documents to a particular geographic location in the database to aid in searching and locating. Translation algorithms may be specifically designed to work with the types of records being operated on. Exemplary translation algorithms are more fully described in previously-incorporated Provisional U.S. Patent Application No. ______, entitled “CONFIDENCE-BASED NATURAL LANGUAGE PARSING” (Attorney Docket No. 040143-000500), and in Provisional U.S. Patent Application No. ______, entitled “CONTEXTUAL CONVERSION OF LANGUAGE TO DATA” (Attorney Docket No. 040143-000600). In some embodiments, the digitizing process is performed manually. For example, data entry clerks may view the content of a data region and manually enter the content into an input device. The process may be highly automated. For example, the input system may be programmed to extract data regions from many documents and present them one-at-a-time to a clerk who reads the information and keys it into an input device. Many other examples are possible, including those that use a combination of electronic and manual data entry.

It is to be understood that the data input method 400 is but one example of a process for reducing recorded documents to searchable data. Other such methods may include more, fewer, or different operations. Further, the operations described herein may be performed in different orders than just described. Those skilled in the art will recognize a number of such possibilities in light of this disclosure.

Attention is directed to FIGS. 5A-5F, which illustrate exemplary output documents according to embodiments of the invention. Exemplary electronic output is illustrated in FIGS. 6B, 6C, and 6F. FIG. 5A illustrates a first section of an exemplary title abstract. This exemplary section includes Vesting Deed Information and Legal Description(s) of Subject Property. FIG. 5B illustrates a second exemplary section of a title abstract. In some embodiments, the title abstract includes all data needed by an examiner to underwrite a policy or loan using commonly-accepted underwriting rules. Thus, the examiner need not refer to the source documents to complete the underwriting process.

The abstract may include a list of relevant documents. In some embodiments, this list contains only enough information for a searcher to locate documents manually. The list may include a relevance score, which may be determined in any of a number of ways. For example, documents having an address that correlates perfectly with the parcel may be considered highly relevant, while documents having the same grantee but a different property address may be considered less so. Many other examples exist. A document's relevance may be expressed as a percentage and ranked accordingly on the output document. Those skilled in the art will recognize other possibilities in light of this disclosure.

Additionally, the title abstract may include a score, grade, or exceptions list that provides an indication of the quality of the title as it relates to the marketability of the property it represents. In other words, parcels with “clean” titles will have more favorable scores. The score could be used to approve a loan, commit to a loan, determine settlement fees and/or closing costs associated with closing a loan, and/or the like. A title score may be calculated in any of a number of ways using a variety of factors. For example, factors may include: the number and types of documents relating to the parcel; the presence of judgments, tax liens, lis pendens, and/or the like; chain of title breaks; unusual vesting and/or ownership conditions; insurance claims history; and the like. Each of these factors may include conditions within. For example, with respect to the number and types of documents relating to the parcel, additional considerations may include: unreleased encumbrances; modified or assigned encumbrances; and the like. With respect to judgments, tax liens and lispendens, consideration may be given to whether these encumbrances are within the statute of limitations for the particular jurisdiction for that type of judgment. Breaks in a chain of title may be reconciled with other documents such as divorce decrees, death certificates, and the like. Many other examples are possible and apparent to those skilled in the art in light of this disclosure.

With respect to calculating the actual score based on the foregoing factors, many possibilities exist. For example, each of the various factors and sub factors may receive a particular weighting, and the presence or absence of particular conditions may be combined with the weighting to determine the final score. As another example, any of a number of conditions may receive a value, and the values for all conditions may be combined to arrive at the score or detract from an ideal score. Many such possibilities exist and are apparent to those skilled in the art in light of this disclosure. In some examples the title score is a title grade, such as a letter grade. In some embodiments, the summary is a list of exceptions such as unreleased liens and mortgages, unresolved judgments, and the like.

FIG. 5C illustrates a first page of a commitment that may be produced according to some embodiments. FIG. 5D illustrates a second page that includes conditions that must be met before a policy will be issued based on the commitment. FIGS. 5C and 5D illustrate a commitment for an owner's policy in the amount of $225,000. Thus, a mortgage company may obtain a title commitment electronically merely by requesting one via the Internet. The title commitment illustrates in FIGS. 5C and D may be automatically produced, in some embodiments, following a process of automated title examination, wherein business rules are used to accomplish the process previously performed manually. Title policies and other such documents may be generated similarly.

FIGS. 5E and 5F illustrate two pages from a policy that may be produced according to some embodiments. These pages represent a lender's policy. FIG. 5E illustrates Schedule A, which includes the basic policy information; FIG. 5F illustrates Schedule B, which includes the Exceptions from Coverage.

Attention is directed to FIGS. 6A-6F, which illustrate a series of display screens that a user may view in the process of interacting with the system described herein. These display screens are merely exemplary, as will be appreciated by those skilled in the art. The display screens may be produced by the network interface 116 of FIG. 1, which may be, for example, a web server. The screens then may be viewed using browser software residing on a user device, such as a personal computer, as is known in the art. FIG. 6A illustrates a request screen through which a user may request a title search. The screen includes data fields for names, address, county and state. A Search by drop down menu may be used to select from a number of different search methods, including: address; legal description; source document; and the like. Some of these fields may be required fields, while others may be optional. The user completes the required fields and any of the optional fields the user desires to complete. The screen also may include fields for requesting the type of output the user desires. For example, the user may desire a document list, a title abstract, a title policy, and/or the like. Additionally, the user may desire to have a relevance associated with each document and may desire a marketability score or grade for a parcel. Once all the fields are complete, the user may submit the request by selecting the search button.

Those skilled in the art will appreciate that other examples according to embodiments of the invention may have the fields on different display screens. Other examples may use more or fewer screens and fields. For example, other display screens may include payment fields, account setup and management fields and the like. Many variations are possible.

FIG. 6B illustrates an exemplary document list display screen that may be returned to the user. This list includes documents identified in the search. The list may be color coded to provide the user with additional information as more fully explained in previously-incorporated U.S. patent application Ser. No. ______, entitled “DOCUMENT ORGANIZATION AND FORMATTING FOR DISPLAY” (Attorney Docket No. 040143-000400). The list may include a relevance score for each document as previously described. The list may include hyperlinks or buttons for requesting more detailed information about the identified documents, including an image of the document. Many other examples are possible.

FIG. 6C illustrates an exemplary document summary screen according to an embodiment of the invention. The document summary screen includes relevant information from a selected document.

FIGS. 6D and 6E illustrate first and second portions of an options screen that may be used to define the type of output the user desires.

FIG. 6F illustrates a title abstract display screen according to embodiments of the invention. The title abstract may include a marketability score or grade as previously described. Using the abstract, an examiner may underwrite a policy without reference to the source documents from which the abstract was generated.

Having described several embodiments, it will be recognized by those of skill in the art that various modifications, alternative constructions, and equivalents may be used without departing from the spirit and scope of the invention. Additionally, a number of well known processes and elements have not been described in order to avoid unnecessarily obscuring the present invention. For example, those skilled in the art know how to arrange computers into a network and enable communication among the computers. Additionally, those skilled in the art will realize that the present invention is not limited to real property records searching specifically or property records searching generally. For example, the present invention may be used to search corporate filings, license records, and the like. Accordingly, the above description should not be taken as limiting the scope of the invention, which is defined in the following claims.

1. A computerized method of searching property records relating to a specific parcel, the method comprising:
receiving property record data for a plurality of parcels into a computer system, wherein the property record data relates to source property record documents;
storing the property record data in a searchable database;
receiving into the computer system an identifier;
in the computer system, using the identifier to search the database and select from the property record documents a set of relevant documents relating to the parcel;
in the computer system, using the set of relevant documents to produce a data summary; and
outputting the data summary from the computer system;
wherein the data summary comprises information from which an underwriter can underwrite a title policy, using commonly-accepted title policy underwriting rules, without reference to the source documents, or images thereof, from which the data summary originated.

2. The method of claim 1, wherein the title policy comprises a selection from the group consisting of:
American Land Title Association (ALTA) Loan Policy;
ALTA Owner's Policy;
ALTA Short Form Residential Loan Policy;
Homeowner's Policy of Title Insurance for a One-to-Four Family Residence;
Standard Exceptions to the ALTA Loan Policy; and
endorsements to an ALTA policy.

3. The method of claim 1, wherein the data summary comprises a display screen on a computer monitor.

4. The method of claim 1, wherein the data summary comprises a printed document.

5. The method of claim 4, wherein the printed document comprises a title abstract.

6. The method of claim 5, wherein the title abstract is generated exclusively from the property record data.

7. The method of claim 4, wherein the printed document comprises a policy.

8. The method of claim 1, wherein the data summary comprises a stream of data directed to a second computer system that is different from the first computer system.

9. The method of claim 8, further comprising thereafter using the stream of data to populate a document, wherein the document comprises a selection from the group consisting of: policy, deed, mortgage, commitment, closing-related document, template, and form.

10. The method of claim 1, further comprising:
creating at least one index relating to the property record data; and
using the at least one index together with the identifier to select relevant documents.

11. The method of claim 1, wherein using the identifier to search the database and select from the property record documents a set of relevant documents relating to the parcel comprises:
in the computer system, using the identifier to search the database and select from the property record documents a set of potentially relevant documents relating to the parcel; and
in the computer system, applying logic to organize the documents.

12. The method of claim 11, wherein applying logic to organize the documents comprises:
relating one or more documents to one or more other documents to identify any unreleased mortgages.

13. The method of claim 11, wherein applying logic to organize the documents comprises:
relating one or more documents to one or more other documents to identify any defective transfers.

14. The method of claim 11, wherein applying logic to organize the documents comprises:
relating one or more documents to one or more other documents to identify any unreleased liens.

15. The method of claim 11, wherein applying logic to organize the documents comprises:
relating one or more documents to one or more other documents to identify a good stop in a chain of title.

16. The method of claim 1, wherein relevant documents include:
deeds, mortgages, assignments, liens, mortgage releases, lien releases, and tax assessor's reports.

17. The method of claim 1, wherein the property record data is received into the computer system before the relevant document set is selected.

18. The method of claim 1, wherein the identifier comprises a selection from the group consisting of grantor name, legal description of the parcel, physical address of the parcel, and a specific recorded document.

19. The method of claim 1, wherein receiving property record data for a plurality of parcels into a computer system comprises:
receiving a plurality of images representing property records;
converting the images to electronic image data;
paginating the electronic image data into related groups representing individual documents;
identifying the document type;
identifying data fields on each document;
using a combination of computer-implemented processes and manual processes to convert information in the data fields into electronic information; and
organizing the electronic information into data records.

20. The method of claim 1, wherein the data summary comprises a listing of the relevant documents.

21. The method of claim 20, wherein the listing of the relevant documents includes a score for at least one of the documents that indicates the degree of relevance of the document.

22. The method of claim 20, wherein the listing of the relevant documents comprises a hyperlink for at least one of the documents that returns an image of the document.

23. The method of claim 1, wherein the data summary includes a score that provides an indication of the marketability of the parcel.

24. The method of claim 23, wherein the score comprises a grade.

25. A system for generating a data summary relating to a specific parcel, wherein the data summary includes data from which an underwriter can issue a commitment or approve a loan, using commonly-accepted underwriting rules, without reference to source documents from which the data for the data summary originated, the system comprising:
a host computer system having a processor;
a storage arrangement in communication with the processor; and
software that programs the processor to:
receive property record data for a plurality of parcels, wherein the property record data relates to source property record documents;
store the property record data in a searchable database in the storage arrangement;
receive an identifier;
use the identifier to search the database and select from the property record documents a set of relevant documents relating to the parcel;
use the set of relevant documents to produce the data summary; and
output the data summary.

26. The system of claim 25, further comprising a computer monitor for displaying the data summary.

27. The system of claim 25, further comprising means for producing a printed document from the data summary.

28. The system of claim 25, further comprising a communications arrangement for directing the data summary to a second computer system that is different from the first computer system.

29. The system of claim 25, further comprising an input system comprising:
means for receiving a plurality of images representing property records;
means for converting the images to electronic image data;
means for paginating the electronic image data into related groups representing individual documents;
means for identifying the document type;
means for identifying data fields on each document;
means for using a combination of computer-implemented processes and manual processes to convert information in the data fields into electronic information; and
means for organizing the electronic information into data records.

30. A computer-readable medium having stored thereon computer executable instruction for implementing a computerized method of searching property records relating to a specific parcel, the method comprising:
receiving property record data for a plurality of parcels into a computer system, wherein the property record data relates to source property record documents;
storing the property record data in a searchable database;
receiving into the computer system an identifier;
in the computer system, using the identifier to search the database and select from the property record documents a set of relevant documents relating to the parcel;
in the computer system, using the set of relevant documents to produce a data summary; and
outputting the data summary from the computer system;
wherein the data summary comprises information from which an underwriter can underwrite a title policy, using commonly-accepted title policy underwriting rules, without reference to the source documents, or images thereof, from which the data summary originated.

31. The computer-readable medium of claim 30, wherein the method further comprises:
creating at least one index relating to the property record data; and
using the at least one index together with the identifier to select relevant documents.

32. The computer-readable medium of claim 30, wherein the data summary includes a score that provides an indication of the marketability of the parcel.

33. The computer-readable medium of claim 32, wherein the score comprises a grade.

34. A method of searching property records, comprising:
receiving property record data relating to a plurality of parcels into a computer system, wherein the data relates to source documents;
storing the data in a searchable database;
receiving into the computer system a request for data summary relating to the specific parcel;
using the data to generate the data summary;
outputting the data summary; and
using the data summary to underwrite a title policy without reference to the source documents;
wherein the property record data is received before the data summary is requested.

35. The method of claim 34, wherein the data summary comprises a stream of data directed to a second computer system that is different from the first computer system.

36. The method of claim 35, further comprising thereafter using the stream of data to populate a document, wherein the document comprises a selection from the group consisting of: policy, deed, mortgage, and commitment.

37. The method of claim 34, wherein the data summary comprises a listing of the relevant documents.

38. The method of claim 37, wherein the listing of the relevant documents includes a score for at least one of the documents that indicates the degree of relevance of the document.

39. The method of claim 37, wherein the listing of the relevant documents comprises a hyperlink for at least one of the documents that returns an image of the document.

40. The method of claim 34, wherein the data summary includes a score that provides an indication of the marketability of the parcel.

41. The method of claim 40, wherein the score comprises a grade.

42. A method of searching property records, comprising:
receiving property record data relating to a plurality of parcels into a computer system, wherein the data relates to source documents;
storing the data in a searchable database;
receiving into the computer system a request for data summary relating to the specific parcel;
using the data to generate the data summary;
displaying the data summary; and
using the data summary to issue a commitment for a title policy without reference to the source documents;
wherein the property record data is received before the data summary is requested.

43. The method of claim 42, wherein the data summary comprises a stream of data directed to a second computer system that is different from the first computer system.

44. The method of claim 43, further comprising thereafter using the stream of data to populate a document, wherein the document comprises a selection from the group consisting of: policy, deed, mortgage, and commitment.

45. The method of claim 42, wherein the data summary comprises a listing of the relevant documents.

46. The method of claim 45, wherein the listing of the relevant documents includes a score for at least one of the documents that indicates the degree of relevance of the document.

47. The method of claim 46, wherein the listing of the relevant documents comprises a hyperlink for at least one of the documents that returns an image of the document.

48. The method of claim 42, wherein the data summary includes a score that provides an indication of the marketability of the parcel.

49. The method of claim 48, wherein the score comprises a grade.
